(19) United States
(12) Patent Application Publication
(10) Pub. No.: US 2023/0179807 A1
(43) Pub. Date: Jun. 8, 2023

(54) INFORMATION PROCESSING APPARATUS, VIDEO DISTRIBUTION TERMINAL, AND VIDEO DISTRIBUTION METHOD

(71) Applicant: SONY GROUP CORPORATION, TOKYO (JP)

(72) Inventor: NORIYUKI KATO, TOKYO (JP)

(21) Appl. No.: 17/995,492

(22) PCT Filed: Apr. 15, 2020
(86) PCT No.: PCT/JP2020/016641

§ 371 Date: Oct. 15, 2022

(51) Int. Cl. H04N 21/2187; G09G 5/36; G09B 29/10

(52) U.S. Cl. CPC H04N 21/2187; G09G 5/36; G09B 29/106; G09G 2340/04; G09G 2320/0666

(57) ABSTRACT

[Object] To solve various issues caused upon operation of real-time video sharing services and to improve the quality of the services.

[Solving Means] The information processing apparatus includes a controller that performs control such that a piece of video data with a point of view of a video distribution terminal is distributed to a video viewing terminal of a viewer, the piece of video data being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.

### TECHNICAL FIELD

The present technology relates to an information processing apparatus, a video distribution terminal, and a video distribution method that are used to provide real-time video sharing services.

### BACKGROUND ART

For example, services are known that distribute real-time videos of various scenes of events such as various sports competitions and exhibitions. The mainstream of these kinds of services is services in which a camera staff captures a video in a location assigned to the camera staff and a video selected by, for example, a director from the videos captured using the respective cameras, is distributed to a viewer.

For example, Patent Literature 1 discloses a technology used to share videos respectively captured by a plurality of camera operators in the same facility.

### CITATION LIST

### Patent Literature

Patent Literature 1: Japanese Patent Application Laid-open No. 2008-61193

### DISCLOSURE OF INVENTION

### Technical Problem

However, in recent years, a bandwidth available for users to upload data has been increased, and this enables general users to capture a high-resolution video using, for example, a smartphone and to distribute a real-time video. In order to supply, using videos captured by general users, viewers with real-time videos captured in respective locations of an event, as described above, there are complicated issues that include, for example, calling together users who are camera operators, assigning locations for video capturing, and selecting a video from videos captured by the respective users.

It is an object of the present technology to provide an information processing apparatus, a video distribution terminal, and a video distribution method that make it possible to solve various issues caused upon operation of real-time video sharing services and to improve the quality of the services.

### Solution to Problem

In order to solve the issues described above, an information processing apparatus according to the present technology includes a controller that performs control such that a piece of video data with a point of view of a video distribution terminal is distributed to a video viewing terminal of a viewer, the piece of video data being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.

The controller may be configured to generate a map obtained by arranging, on the plan including the area set on the plan, at least one camera mark corresponding to the at least one video distribution terminal on the basis of position information regarding a position of the at least one video distribution terminal of the at least one camera operator; to distribute the generated map to the video viewing terminal; and to perform control such that a piece of video data with a point of view of the video distribution terminal corresponding to a camera mark discretionarily selected by the viewer on the map from the at least one camera mark, is distributed to the video viewing terminal.

The at least one camera mark arranged on the map may be limited to a camera mark corresponding to the video distribution terminal situated in the area.

Further, the controller may be configured to change a display mode for the at least one camera mark on the basis of a viewing state of video data for each video distribution terminal.

The changed display mode for the at least one camera mark may be at least one of a size, a color, or transparency.

The controller may be configured to change an assignment amount of network resources in real time on the basis of a viewing state of video data for each video distribution terminal.

The area may be partitioned into a plurality of small areas, and at least one small area that is from among the plurality of small areas and in which distribution of captured-video data is allowed, may be assigned for each video distribution terminal. The controller may be configured such that the distribution of captured-video data is allowed only in the at least one small area assigned for each video distribution terminal.

Alternatively, the area may be partitioned into a plurality of small areas, and the controller may be configured such that at least one of an upper limit or a lower limit of the number of video distribution terminals allowed to participate in distributing video data is settable for each small area.

A video distribution terminal according to another aspect of the present technology includes a controller that performs control such that a piece of data of a video captured using an image-capturing section is distributed to a video viewing terminal of a viewer in accordance with a distribution instruction given by a server that performs control such that a piece of video data with a point of view of the video distribution terminal is distributed to the viewing terminal of the viewer, the piece of video data with the point of view of the video distribution terminal being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.

Further, the controller may be configured to transmit position information regarding a position of the video viewing terminal to the server, and the controller may be configured to distribute, to the video viewing terminal of the viewer, a piece of video data with a point of view of the video distribution terminal corresponding to a camera mark in accordance with an instruction to distribute the piece of video data, the camera mark being selected by the viewer on a map from at least one camera mark corresponding to the at least one video distribution terminal, the map being generated in the server by arranging the at least one camera mark on the plan including the area on the basis of the position information.

A video distribution method according to yet another aspect of the present technology includes distributing, to at least one video viewing terminal of a viewer, a piece of video data with a point of view of a video distribution terminal, the piece of video data being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.

### BRIEF DESCRIPTION OF DRAWINGS

FIG. 1 is a block diagram illustrating an overall configuration of an information processing system of a first embodiment according to the present technology.

FIG. 2 is a block diagram illustrating a functional configuration of a camera operator's terminal, a viewer's terminal, and a server that are included in the information processing system of FIG. 1.

FIG. 3 illustrates an example of a camera map.

FIG. 4 is a flowchart of on/off control on display of a camera mark.

FIG. 5 is a diagram used to describe deleting, from a camera map, a camara mark that corresponds to a camera operator's terminal being moved from the inside to the outside of a camera available area.

FIG. 6 is a diagram used to describe a method for selecting a camera mark on a camera map.

FIG. 7 is a diagram used to describe a method for displaying a camera mark that corresponds to a camera operator's terminal that is distributing video data.

FIG. 8 illustrates an example in which a display mode for a camera mark on a camera map is changed according to a viewing state.

FIG. 9 illustrates an example of a camera map including a camera available area partitioned into a plurality of small areas.

### MODE(S) FOR CARRYING OUT THE INVENTION

Embodiments according to the present technology will now be described below with reference to the drawings.

<Overview of Present Embodiment>

In recent years, a bandwidth available for users to distribute data such as video data has been increased, and this enables a certain user to distribute, to a user terminal such as a smartphone of another user, a video such as a high-resolution moving image captured by the certain user using, for example, a user terminal of the certain user, and enables a real-time video to be shared between the user terminals. It is an object of the present technology to improve the quality of such real-time video sharing services between user terminals.

In order to improve the quality of such real-time video sharing services, a server that is an information processing apparatus of an aspect according to the present technology includes a controller that performs control such that a piece of video data with a point of view of a camera operator's terminal is distributed to a viewer's terminal such as a smartphone of a certain user (viewer), the piece of video data being discretionarily selected by the viewer from at least one video with a different point of view, the camera operator's terminal being from among at least one camera operator's terminal such as a smartphone of at least one another user (camera operator) who is in a real space that corresponds to an available area set on a plan, the at least one video being captured using the at least one camera operator's terminal.

More specifically, on the basis of position information regarding a position of at least one camera operator's terminal that is transmitted by the at least one camera operator's terminal, and on the basis of information regarding an available area, the controller of the server generates a camera map obtained by arranging, in visible information, at least one camera mark indicating a position of each camera operator's terminal, the visible information being obtained by making the available area spatially visible, and the controller of the server distributes the generated camera map to a viewer's terminal. Further, the controller of the server receives selection information regarding a camera operator's terminal selected by a viewer discretionarily on the camera map, and performs control, on the basis of the selection information, such that a piece of video data with a point of view of the corresponding camera operator's terminal is distributed to the viewer's terminal.

Embodiments according to the present technology embodiment are described in detail below.

### First Embodiment

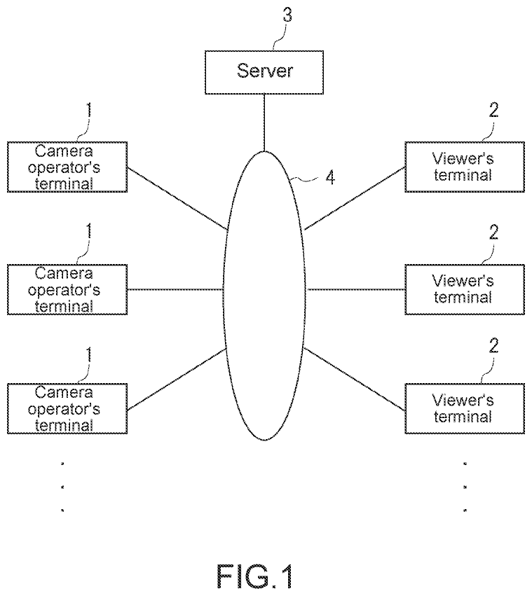

FIG. 1 is a block diagram illustrating an overall configuration of an information processing system of a first embodiment according to the present technology.

As illustrated in the figure, an information processing system 100 includes at least one camera operator's terminal 1, at least one viewer's terminal 2, a server 3, and a transmission line 4 such as a network.

The camera operator's terminal 1 (a video distribution terminal) is an apparatus that includes, for example, an image-capturing device including an imaging device such as a complementary metal-oxide semiconductor (CMOS) sensor or a charge coupled device (CCD) image sensor; a Global Positioning System (GPS) receiver; a communication device; an input device of a user; a microphone; a central processing unit (CPU); and a memory such as a random access memory (RAM). More specifically, examples of the camera operator's terminal 1 include a smartphone, a tablet terminal, a personal computer, and a camera apparatus with a communication function.

The viewer's terminal 2 (a video viewing terminal) is an apparatus that includes, for example, a display, an input device of a user, a speaker, a communication device, a CPU, and a memory. More specifically, examples of the viewer's terminal 2 include a smartphone, a tablet terminal, and a personal computer, as in the case of the camera operator's terminal 1.

The server 3 includes, for example, a CPU, a memory, a storage device, a communication device, an input device, and a display.

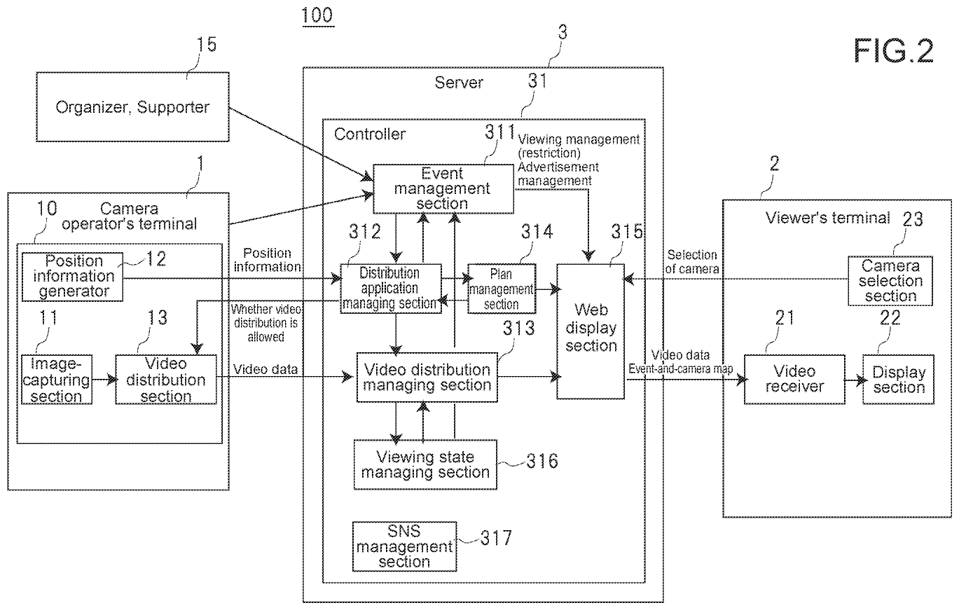

FIG. 2 is a block diagram illustrating a functional configuration of the camera operator's terminal 1, the viewer's terminal 2, and the server 3.

The server 3 includes a controller 31. The controller 31 includes, for example, a computation processing circuit such as a CPU, and a memory. The controller 31 performs information processing and control for real-time video sharing services on the basis of a program stored in the memory. The controller 31 includes, as a functional section for the real-time video sharing services, an event management section 311, a distribution application managing section 312, a video distribution managing section 313, a plan management section 314, a Web display section 315, a viewing state managing section 316, and a social networking service (SNS) management section 317.

The camera operator's terminal 1 includes a controller 10 that performs control regarding the use of real-time video sharing services. The controller 10 includes an image-capturing section 11, a position information generator 12 that generates position information regarding a position of the camera operator's terminal 1 using a Global Positioning System (GPS) receiver, and a video distribution section 13 that distributes data of a video captured using the image-capturing section 11 to the viewer's terminal 2 indicated by the server 3 through the transmission line 4.

The viewer's terminal 2 includes, as a functional section used to use the real-time video sharing services, a video receiver 21 that receives the video data distributed by the camera operator's terminal 1 and a camera map transmitted by the server 3, a display section 22 that displays thereon the received video data and camera map, and a camera selection section 23.

(Regarding Camera Map)

The event management section 311 manages, for example, information regarding an event planned by, for example, an organizer/a supporter 15 (for example, a place for an event, a period of the event, a supporter, and a support fee), information regarding a camera operator and the camera operator's terminal 1, which are allowed to capture a video of the event, and information regarding a viewer and the viewer's terminal 2. The information regarding a camera operator and the camera operator's terminal 1 includes a condition for, for example, a restriction on video distribution. The information regarding a viewer and the viewer's terminal 2 includes information regarding, for example, a restriction on video reception and a restriction on video viewing. Further, as the information regarding an event, the event management section 311 manages, for example, information regarding a place for an event, and information regarding a camera available area that is set on a plan covering the place for the event. Furthermore, the event management section 311 manages an advertisement distribution to a viewer and the viewer's terminal 2.

The Web display section 315 generates the camera map on the basis of information regarding a place for an event and information regarding a camera available area that are managed by the event management section 311, and on the basis of plan information regarding a plan covering the place for the event that is acquired by the plan management section 314, and on the basis of information regarding a position of the camera operator's terminal 1. The Web display section 315 distributes the generated camera map to the viewer's terminal 2 connected to the server 3, and presents the generated camera map to a viewer through the display section 22 of the viewer's terminal 2.

Note that, on the basis of information regarding an event that is managed by the event management section 311, the plan management section 314 acquires plan information regarding a plan covering a place for an event by, for example, accessing a plan viewing site on the Web.

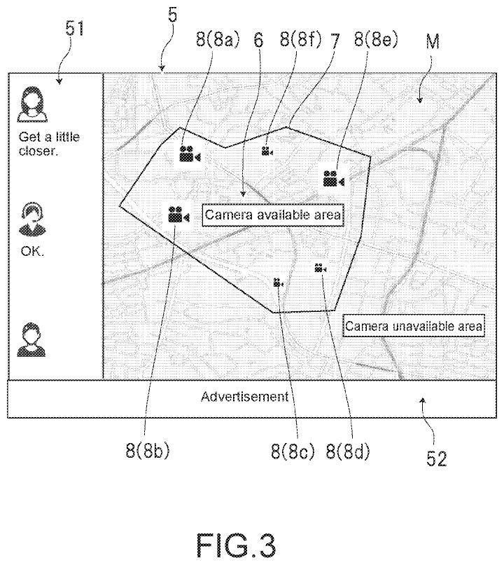

FIG. 3 illustrates an example of a camera map.

As illustrated in the figure, a camera map 5 includes, for example, a plan image M of a plan covering a place for an event, a geofence 7 that indicates a boundary line of a camera available area 6 superimposed on the plan image M, and a camera mark 8 that indicates a position of the camera operator's terminal 1. Further, in addition to the camera map 5, the display section 22 of the viewer's terminal 2 includes an SNS area 51 that displays thereon details of communication with an SNS, and an advertisement area 52 that displays thereon an advertisement.

The camera available area 6 is an area in which a distribution of video data from the camera operator's terminal 1 to the server 3 is available. The camera available area 6 is set on the basis of information regarding the camera available area 6 that is managed by the event management section 311, and is displayed on the camera map 5 in the form of the geofence 7 indicating the boundary of the camera available area 6. The camera operator's terminal 1 situated in the camera available area 6 in a real space is displayed on the camera map 5 in the form of a specified camera mark 8, and a camera mark of the camera operator's terminal 1 situated outside of the camera available area 6 is not displayed on the camera map 5.

(On/Off Control on Display of Camera Mark)

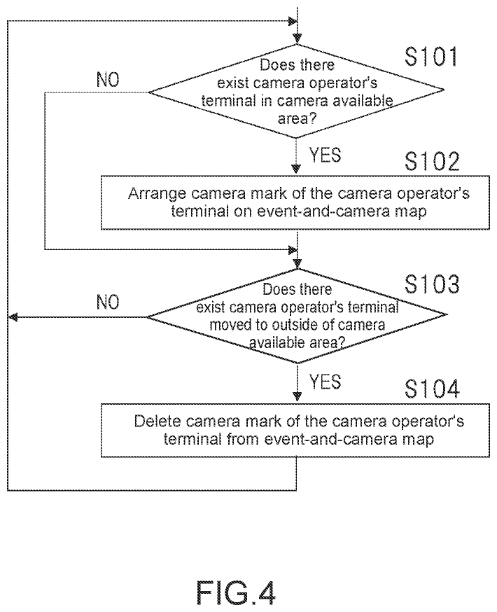

FIG. 4 is a flowchart of on/off control on display of a camera mark.

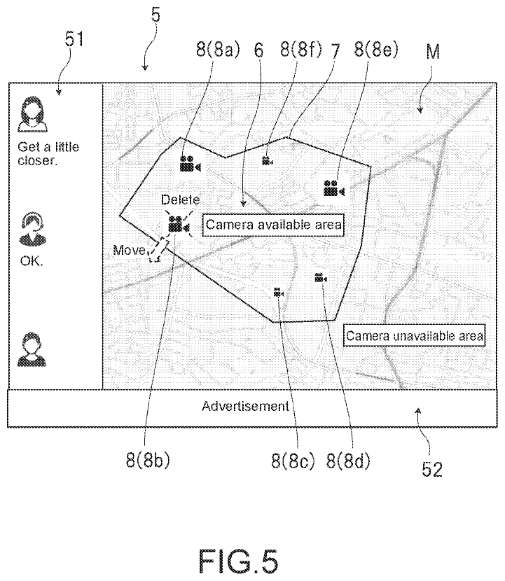

On the basis of position information regarding a position of the camera operator's terminal 1 that is transmitted by the camera operator's terminal 1, and on the basis of information regarding the camera available area 6, the distribution application managing section 312 in the server 3 determines whether the camera operator's terminal 1 is in the camera available area 6 in a real space (Step S101). When the camera operator's terminal 1 is in the camera available area 6 (Yes in Step S101), the distribution application managing section 312 arranges, on the camera map 5, the camera mark 8 of the camera operator's terminal 1 being in the camera available area 6, on the basis of position information regarding a position of the camera operator's terminal 1 being in the camera available area 6 (Step S102). Further, when the distribution application managing section 312 detects the camera operator's terminal 1 being moved from the inside to the outside of the camera available area 6 (Yes in Step S103), the distribution application managing section 312 deletes, from the camera map 5, a camera mark 8b corresponding to the camera operator's terminal 1 being moved to the outside of the camera available area 6 (Step S104), as illustrated in FIG. 5.

(Control on Video Distribution Performed by Camera Operator's Terminal 1)

On the basis of position information regarding a position of the camera operator's terminal 1 and information regarding the camera available area 6, the distribution application managing section 312 in the server 3 determines whether video distribution from the camera operator's terminal 1 to the viewer's terminal 2 is allowed, and notifies the video distribution section 13 of a result of it. On the basis of the notification, the video distribution section 13 of the camera operator's terminal 1 determines whether data of a video captured using the image-capturing section 11 is allowed to be distributed. Specifically, the distribution application managing section 312 notifies the camera operator's terminal 1 in the camera available area 6 that the video data is allowed to be distributed, and the distribution application managing section 312 notifies the camera operator's terminal 1 outside of the camera available area 6 that distribution of the video data is prohibited, or does not give notification that the video data is allowed to be distributed.

The video distribution section 13 of the camera operator's terminal 1 keeps on distributing video data to the server 3 as long as notification that video data is allowed to be distributed is received.

This results in the camera operator's terminal 1 allowed to distribute video data and a position of that camera operator's terminal 1 being presented to a viewer on the camera map 5 using the camera mark 8. This enables the viewer to view, by just selecting the camera mark 8, a video of a location, in an event, that is desired by the viewer.

(Selection of Video (Camera Operator's Point of View) Using Camera Mark)

The camera selection section 23 in the viewer's terminal 2 receives selection of any camera mark 8 from at least one camera mark 8 that is performed by a viewer, the at least one camera mark 8 being arranged on the camera map 5 displayed on the display section 22, and the camera selection section 23 in the viewer's terminal 2 notifies the server 3 of a result of it.

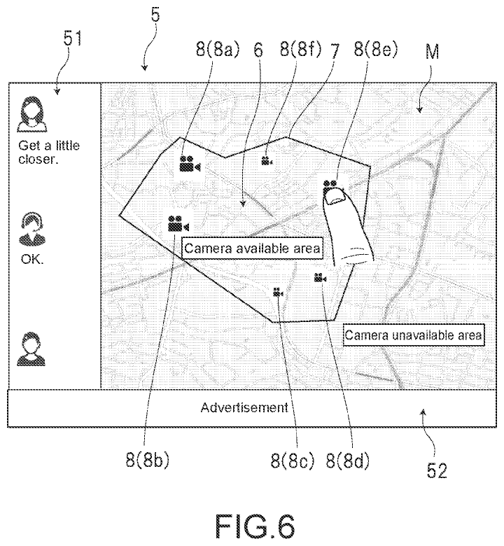

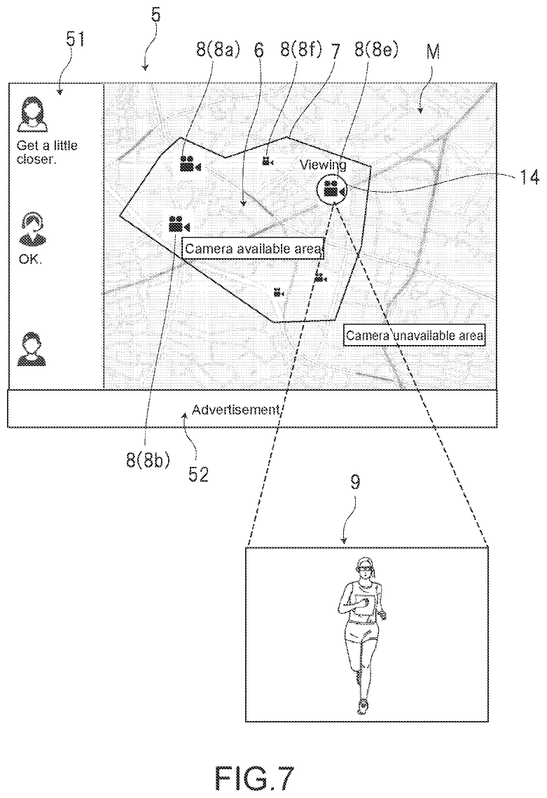

For example, as illustrated in FIGS. 6 and 7, a viewer touches to select any camera mark (for example, 8e) on the camera map 5 displayed on the display section 22 of the viewer's terminal 2. Consequently, video data 9 is distributed to the viewer's terminal 2 by the camera operator's terminal 1 corresponding to the camera mark 8e, and displayed on the display section 22 of the viewer's terminal 2. When the distribution of the video data to the viewer's terminal 2 and the display of the video data on the viewer's terminal 2 are being performed, a mark 14 indicating that the video is being viewed is added to the corresponding camera mark 8e on the camera map 5.

The SNS management section 317 manages communication performed between a viewer of the viewer's terminal 2 and a camera operator of the camera operator's terminal 1 using a social networking service (SNS). Details of communication with an SNS are displayed on the SNS area 51 of each of the viewer's terminal 2 and the camera operator's terminal 1, for example, as illustrated in FIG. 3.

(Control on Change in Display Mode for Camera Mark)

The viewing state managing section 316 in the server 3 manages a viewing state such as the number of viewing, the number of simultaneous viewing, and the frequency in viewing with respect to video data for each camera operator's terminal 1. The viewing state obtained by the viewing state managing section 316 is reflected, in real time, in a display mode such as a size, a color, and transparency. Consequently, a viewer can recognize the degree of attention to video data for each camera operator's terminal 1, and this makes it possible to reduce the opportunity for the viewer to miss an exciting scene.

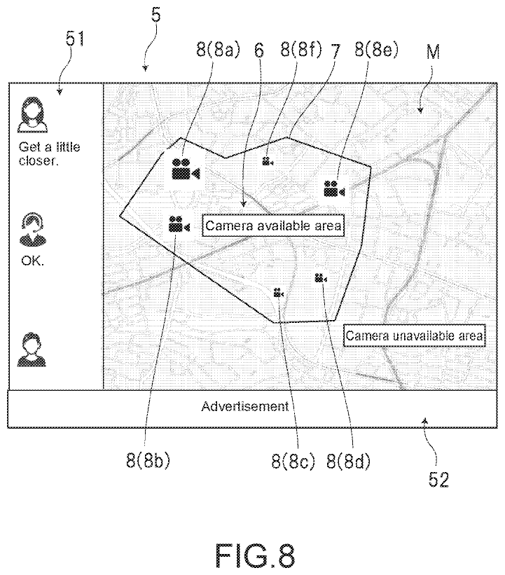

For example, FIG. 3 illustrates an example in which three camera marks 8a, 8b, and 8e have a size different from the size of other camera marks 8c, 8d, and 8f. The viewing state managing section 316 manages a viewing state such as the number of viewing and the number of simultaneous viewing with respect to video data for each camera operator's terminal 1. The viewing state managing section 316 gives the Web display section 315 an instruction to display a camera mark in a more noticeable display mode, such as in a larger size, in a brighter color, or with a lower degree of transparency, if the viewing state exhibits a larger value. In accordance with the instruction given by the viewing state managing section 316, the Web display section 315 controls the display mode for a camera mark. For example, when there is a further increase in the number of simultaneous viewing of video data of the camera operator's terminal 1 corresponding to the camera mark 8a on the camera map in FIG. 3, the camera mark 8a is made even larger in size, as illustrated in FIG. 8.

As described above, when a display mode for a camera mark is changed on the basis of a viewing state, this enables a viewer to grasp, at first sight, a video with a point of view of a camera operator who is now attracting attention.

(Other Processing)

The viewing state managing section 316 also provides the video distribution managing section 313 and the event management section 311 with information regarding a viewing state of video data for each camera operator's terminal 1. On the basis of the information regarding a viewing state of video data for each camera operator's terminal 1, the video distribution managing section 313 changes, for example, an assignment range of network resources such as bands in real time. More specifically, the camera operator's terminal 1 with a larger number of viewers is assigned a wider range of network resources available for distribution of video data. This results in, for example, distribution of higher-resolution video data and low latency distribution.

In the event management section 311, the information regarding a viewing state of video data for each camera operator's terminal 1 can be used to, for example, calculate a reward given to a camera operator.

(Others)

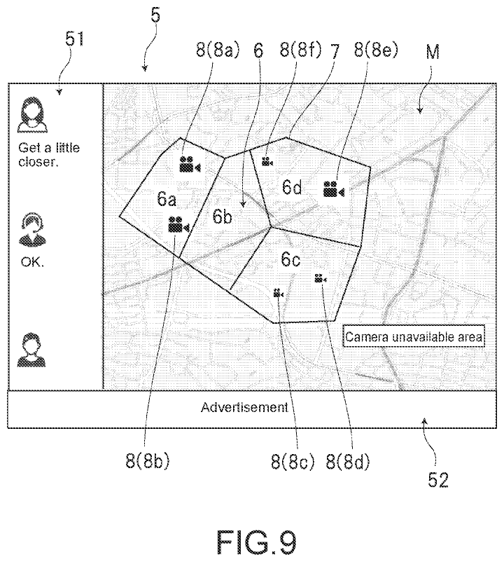

As illustrated in FIG. 9, the camera available area 6 surrounded by the geofence 7 may be partitioned into a plurality of small areas 6a, 6b, 6c, and 6d. Here, the controller 31 may be capable of assigning, for each camera operator's terminal 1, at least one small area in which distribution of captured-video data is allowed, and may perform control such that each camera operator's terminal 1 is allowed to distribute captured-video data only in the at least one small area 6a, 6b, 6c, 6d assigned to the camera operator's terminal 1. Further, the controller 31 may be configured such that at least one of an upper limit or a lower limit of the number of camera operator's terminals 1 allowed to participate in distributing video data can be set for each of the small areas 6a, 6b, 6c, and 6d. This results in avoiding, even in a wide event venue, a state in which a large number of camera operator's terminals 1 gathers in a specific region or a state in which there are no camera operator's terminals 1 in a specific region. This makes it possible to comprehensively secure distribution of video data in the entirety of the event venue. Further, the event management section 311 may select a distribution-target advertisement according to the small area 6a, 6b, 6c, 6d in which there is the camera operator's terminal 1 or the viewer's terminal 2.

The server 3 may include a single information processing apparatus or a plurality of information processing apparatuses. Information processing apparatuses of the plurality of information processing apparatuses included in the server may be arranged by being spread through a network.

Note that the present technology may also take the following configurations.
(1) An information processing apparatus, including

a controller that performs control such that a piece of video data with a point of view of a video distribution terminal is distributed to a video viewing terminal of a viewer, the piece of video data being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.
(2) The information processing apparatus according to (1), in which

the controller is configured
to generate a map obtained by arranging, on the plan including the area set on the plan, at least one camera mark corresponding to the at least one video distribution terminal on the basis of position information regarding a position of the at least one video distribution terminal of the at least one camera operator,
to distribute the generated map to the video viewing terminal, and
to perform control such that a piece of video data with a point of view of the video distribution terminal corresponding to a camera mark discretionarily selected by the viewer on the map from the at least one camera mark, is distributed to the video viewing terminal.
(3) The information processing apparatus according to (2), in which

the at least one camera mark arranged on the map is limited to a camera mark corresponding to the video distribution terminal situated in the area.
(4) The information processing apparatus according to any one of (1) to (3), in which

the controller is configured to change a display mode for the at least one camera mark on the basis of a viewing state of video data for each video distribution terminal.
(5) The information processing apparatus according to (4), in which

the changed display mode for the at least one camera mark is at least one of a size, a color, or transparency.
(6) The information processing apparatus according to any one of (1) to (5), in which

the controller is configured to change an assignment amount of network resources in real time on the basis of a viewing state of video data for each video distribution terminal.
(7) The information processing apparatus according to any one of (1) to (6), in which

the area is partitioned into a plurality of small areas,

at least one small area that is from among the plurality of small areas and in which distribution of captured-video data is allowed, is assigned for each video distribution terminal, and

the controller is configured such that the distribution of captured-video data is allowed only in the at least one small area assigned for each video distribution terminal.
(8) The information processing apparatus according to any one of (1) to (7), in which

the area is partitioned into a plurality of small areas, and

the controller is configured such that at least one of an upper limit or a lower limit of the number of video distribution terminals allowed to participate in distributing video data is settable for each small area.
(9) A video distribution terminal, including

a controller that performs control such that a piece of data of a video captured using an image-capturing section is distributed to a video viewing terminal of a viewer in accordance with a distribution instruction given by a server that performs control such that a piece of video data with a point of view of the video distribution terminal is distributed to the viewing terminal of the viewer, the piece of video data with the point of view of the video distribution terminal being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.
(10) The video distribution terminal according to (9), in which

the controller is configured to transmit position information regarding a position of the video viewing terminal to the server, and

the controller is configured to distribute, to the video viewing terminal of the viewer, a piece of video data with a point of view of the video distribution terminal corresponding to a camera mark in accordance with an instruction to distribute the piece of video data, the camera mark being selected by the viewer on a map from at least one camera mark corresponding to the at least one video distribution terminal, the map being generated in the server by arranging the at least one camera mark on the plan including the area on the basis of the position information.
(11) A video distribution method, including

distributing, to at least one video viewing terminal of a viewer, a piece of video data with a point of view of a video distribution terminal, the piece of video data being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.
(12) The video distribution method according to (11), further including:

generating a map obtained by arranging, on the plan including the area set on the plan, at least one camera mark indicating a position of the at least one video distribution terminal of the at least one camera operator;

distributing the generated map to the video viewing terminal; and

receiving selection of a camera mark corresponding to the video distribution terminal, the selection being discretionarily performed by the viewer on the map from the at least one camera mark.
(13) The video distribution method according to (12), in which

the at least one camera mark arranged on the map is limited to a camera mark corresponding to the video distribution terminal situated in the area.
(14) The video distribution method according to any one of (11) to (13), further including

changing a display mode for the at least one camera mark on the basis of a viewing state of video data for each video distribution terminal.
(15) The video distribution method according to (14), in which

the changed display mode for the at least one camera mark is at least one of a size, a color, or transparency.
(16) The video distribution method according to any one of (11) to (15), further including

changing an assignment amount of network resources in real time on the basis of a viewing state of video data for each video distribution terminal.
(17) The video distribution method according to any one of (11) to (16), in which

the area is partitioned into a plurality of small areas,

at least one small area that is from among the plurality of small areas and in which distribution of captured-video data is allowed, is assigned for each video distribution terminal, and

the distribution of captured-video data is allowed only in the at least one small area assigned for each video distribution terminal.
(18) The video distribution method according to any one of (11) to (17), in which

the area is partitioned into a plurality of small areas, and

at least one of an upper limit or a lower limit of the number of video distribution terminals allowed to participate in distributing video data is set for each small area.

### REFERENCE SIGNS LIST

1 camera operator's terminal
2 viewer's terminal
3 server
5 camera map
6 camera available area
8 camera mark
10 controller
11 image-capturing section
12 position information generator
13 video distribution section
21 video receiver
22 display section
23 camera selection section
31 controller
100 information processing system
311 event management section
312 distribution application managing section
313 video distribution managing section
314 plan management section
315 Web display section
316 viewing state managing section
317 SNS management section

1. An information processing apparatus, comprising
a controller that performs control such that a piece of video data with a point of view of a video distribution terminal is distributed to a video viewing terminal of a viewer, the piece of video data being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.

2. The information processing apparatus according to claim 1, wherein
the controller is configured
to generate a map obtained by arranging, on the plan including the area set on the plan, at least one camera mark corresponding to the at least one video distribution terminal on a basis of position information regarding a position of the at least one video distribution terminal of the at least one camera operator,
to distribute the generated map to the video viewing terminal, and
to perform control such that a piece of video data with a point of view of the video distribution terminal corresponding to a camera mark discretionarily selected by the viewer on the map from the at least one camera mark, is distributed to the video viewing terminal.

3. The information processing apparatus according to claim 2, wherein
the at least one camera mark arranged on the map is limited to a camera mark corresponding to the video distribution terminal situated in the area.

4. The information processing apparatus according to claim 3, wherein
the controller is configured to change a display mode for the at least one camera mark on a basis of a viewing state of video data for each video distribution terminal.

5. The information processing apparatus according to claim 4, wherein
the changed display mode for the at least one camera mark is at least one of a size, a color, or transparency.

6. The information processing apparatus according to claim 1, wherein
the controller is configured to change an assignment amount of network resources in real time on a basis of a viewing state of video data for each video distribution terminal.

7. The information processing apparatus according to claim 1, wherein
the area is partitioned into a plurality of small areas,
at least one small area that is from among the plurality of small areas and in which distribution of captured-video data is allowed, is assigned for each video distribution terminal, and
the controller is configured such that the distribution of captured-video data is allowed only in the at least one small area assigned for each video distribution terminal.

8. The information processing apparatus according to claim 1, wherein
the area is partitioned into a plurality of small areas, and
the controller is configured such that at least one of an upper limit or a lower limit of the number of video distribution terminals allowed to participate in distributing video data is settable for each small area.

9. A video distribution terminal, comprising
a controller that performs control such that a piece of data of a video captured using an image-capturing section is distributed to a video viewing terminal of a viewer in accordance with a distribution instruction given by a server that performs control such that a piece of video data with a point of view of the video distribution terminal is distributed to the viewing terminal of the viewer, the piece of video data with the point of view of the video distribution terminal being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.

10. The video distribution terminal according to claim 9, wherein
the controller is configured to transmit position information regarding a position of the video viewing terminal to the server, and
the controller is configured to distribute, to the video viewing terminal of the viewer, a piece of video data with a point of view of the video distribution terminal corresponding to a camera mark in accordance with an instruction to distribute the piece of video data, the camera mark being selected by the viewer on a map from at least one camera mark corresponding to the at least one video distribution terminal, the map being generated in the server by arranging the at least one camera mark on the plan including the area on a basis of the position information.

11. A video distribution method, comprising
distributing, to at least one video viewing terminal of a viewer, a piece of video data with a point of view of a video distribution terminal, the piece of video data being discretionarily selected by the viewer from at least one piece of video data with a different point of view, the video distribution terminal being from among at least one video distribution terminal of at least one camera operator who is in a real space that corresponds to an area set on a plan, the at least one piece of video data being at least one piece of data of a video that is being captured using the at least one video distribution terminal.
